(19) United States
(12) Patent Application Publication
(10) Pub. No.: US 2024/0315214 A1
(43) Pub. Date: Sep. 26, 2024

(54) FOLDING CAGE

(71) Applicant: Doskocil Manufacturing Company, Inc., Arlington, TX (US)

(72) Inventors: Josiah WILHELM, Arlington, TX (US); Karl BOEHRINGER, Arlington, TX (US); Ron BAGLEY, Arlington, TX (US)

(21) Appl. No.: 18/124,398

(22) Filed: Mar. 21, 2023

(51) Int. Cl. A01K 31/08

(52) U.S. Cl. CPC A01K 31/08

(57) ABSTRACT

A folding cage that includes a base member, an upper member and a plurality of columns. The plurality of columns each extend between the base member and the upper member connecting the base member to the upper member. At least one of the plurality of columns is attached to the base member for pivotal movement with respect thereto and at least one of the plurality of columns is attached to the upper member for pivotal movement with respect thereto.

### BACKGROUND

### Technical Field

The present disclosure generally relates to a folding cage. More specifically, the present disclosure relates to folding cage with an upper member and a base member with two groups of columns where the first group fold against the upper member and the second group folds against the base member for storage.

### Background Information

Pet owners are always seeking new and different toys for their pet's enjoyment. Some toys take up large storage spaces when not in use.

### SUMMARY

It has been discovered that a bird cage with columns that can be folded against an upper member and a base member can be easily stored because the folded bird cage takes up less space than the fully assembled bird cage.

In view of the state of the known technology, one aspect of the present disclosure is to provide a folding cage that includes a base member, an upper member and a plurality of columns. The plurality of columns each extend between the base member and the upper member connecting them to one another. At least one of the plurality of columns is attached to the base member for pivotal movement with respect thereto and at least one of the plurality of columns is attached to the upper member for pivotal movement with respect thereto.

### BRIEF DESCRIPTION OF THE DRAWINGS

Referring now to the attached drawings which form a part of this original disclosure:

FIG. 1 is a top perspective view of a folding cage in accordance with an exemplary embodiment;

FIG. 2 is a bottom perspective view of the folding cage in accordance with the exemplary embodiment;

FIG. 3 is an exploded perspective view of the folding cage showing a base member, a plurality of columns and an upper member in accordance with the exemplary embodiment;

FIG. 4 is a top view of the folding cage in accordance with the exemplary embodiment;

FIG. 5 is a bottom view of the upper member of the folding cage showing three first column retention structures and three second column retention structures in accordance with the exemplary embodiment;

FIG. 6 is a top view of the base member of the folding cage showing three first column retention structures and three second column retention structures in accordance with the exemplary embodiment;

FIG. 7 is a bottom view of the base member in accordance with the exemplary embodiment;

FIG. 8 is a side view of one of the columns removed from the folding cage in accordance with the exemplary embodiment;

FIG. 9 is a first side view of the folding cage in accordance with the exemplary embodiment;

FIG. 10 is a second side view of the folding cage in accordance with the exemplary embodiment;

FIG. 11 is a perspective view of the folding cage in a dis-assembled state for shipping or storage in accordance with the exemplary embodiment;

FIG. 12 is an exploded perspective view of the folding cage in a dis-assembled state with the upper member and the base member separated in preparation for assembly of the folding cage in accordance with the exemplary embodiment;

FIG. 13 is a top view of the base member showing the columns folded such that they are parallel to the base member in accordance with the exemplary embodiment;

FIG. 14 is a bottom view of the upper member showing the columns folded such that they are parallel to the upper member in accordance with the exemplary embodiment; and

FIG. 15 is another exploded perspective view of the folding cage in a dis-assembled state with the columns unfolded such that they are all perpendicular to the upper member and the base member just prior to final assembly of the folding cage in accordance with the exemplary embodiment.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

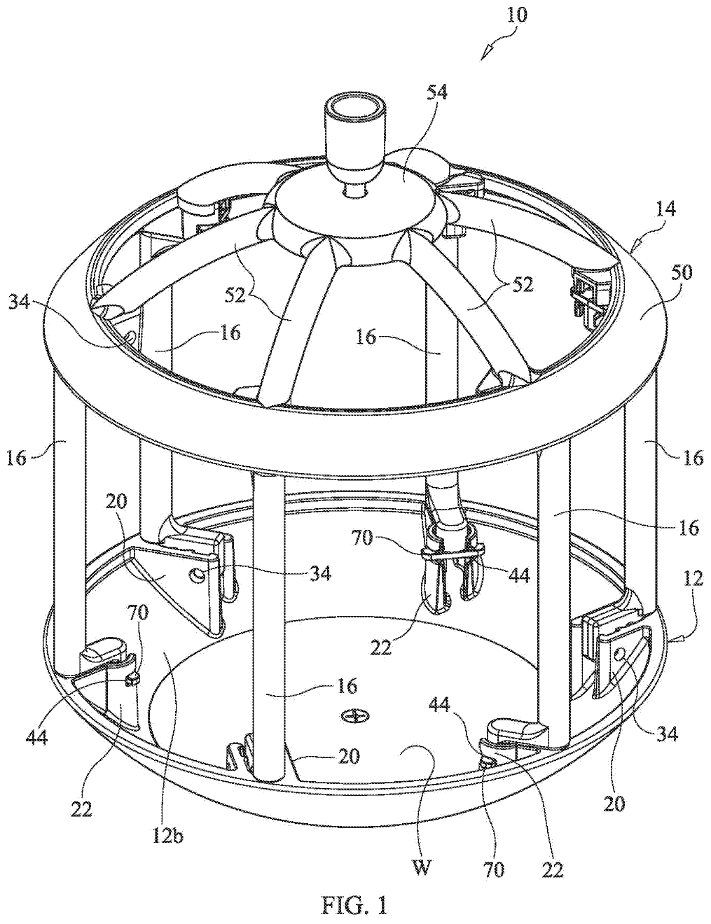

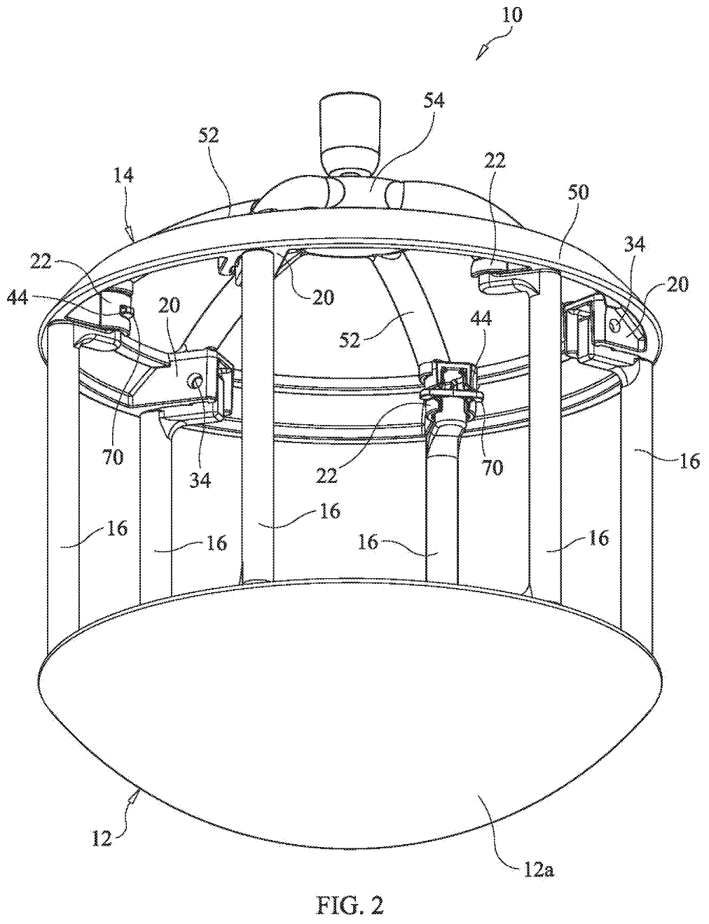

Referring initially to FIGS. 1 and 2, a folding cage 10 (also referred to as a yard bird folding cage) is illustrated in accordance with a first embodiment.

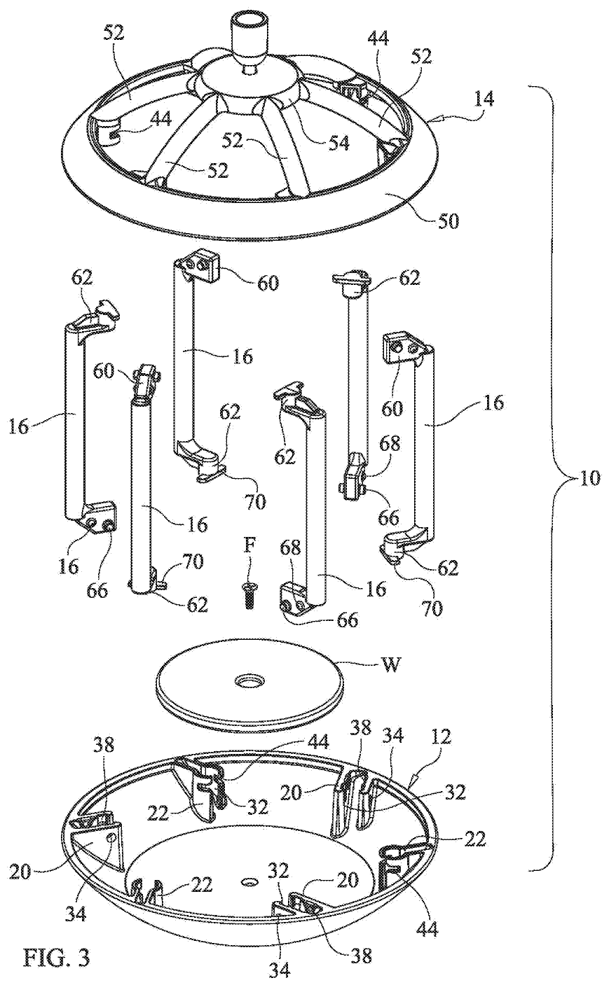

As shown in FIG. 3, the folding cage 10 includes a base member 12, an upper member 14 (a top member) and a plurality of columns 16.

As shown in FIGS. 1, 3 and 6-7, the base member 12 has an overall saucer shape with a convex bottom surface 12a and a convex upper surface 12b. The upper a surface 12b includes three first column retention structures 20 (also referred to as a block 20) and three second column retention structures 22 (also referred to as a block 22).

The first column retention structures 20 and the second column retention structures 22 are arranged in a circle with each of the first column retention structures 20 and each of the second column retention structures 22 extending radially inwardly from a radially outer edge 24 of the base member 12. The first column retention structures 20 and the second column retention structures 22 are arranged in an alternating arrangement such that each of the first column retention structures 20 has one of the second column retention structures 22 on one side thereof and another on an opposite side thereof.

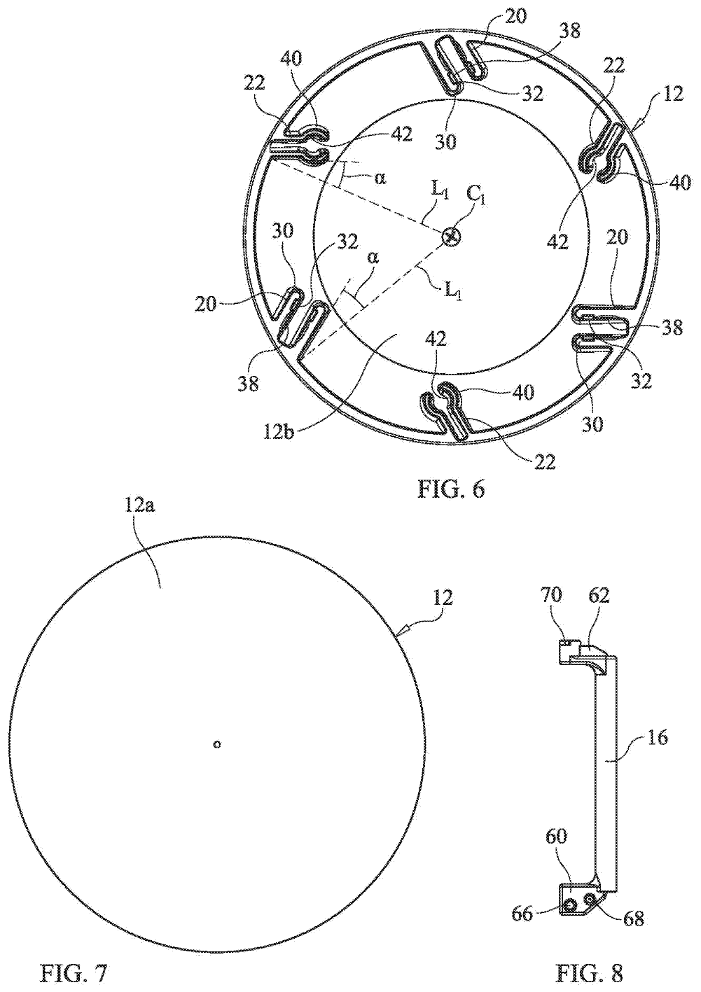

As shown in FIG. 6, the first column retention structures 20 and the second column retention structures 22 extend radially inward from the radially outer edge 24 of the base member 12 but are not aligned to intersect a center C₁ of the base member 12. More specifically, each of the first column retention structures 20 and the second column retention structures 22 is angularly offset from radius lines L₁ that extend from the center C₁ of the base member 12. The first column retention structures 20 and the second column retention structures 22 extend in a direction that is angularly offset from the radius lines L₁ by an angle α. The angle α can be any value between 15 and 30 degrees. In the depicted embodiment, the angle α is approximately 20 degrees.

Each of the first column retention structures 20 includes two parallel wall sections 30 defining a gap 32 therebetween. Each of the two parallel wall sections 30 has an opening 34 dimensioned to receive a pivot pin 66 of one of the plurality of columns 16, as described in greater detail below. Within the gap 32 along each of the parallel wall sections 30 detent areas 38 are defined, as is further described below.

Each of the second column retention structures 22 is defined by a pair of wall sections 40 (another block) that also extend radially inward offset from the line L₁ by the angle α. The wall sections 40 are parallel to one another proximate the radially outer edge 24 of the base member 12 but diverge away from one another defining a snap-fit area 42 that is dimensioned and shaped to receive a portion of a corresponding one of the columns 16, as is described in greater detail below. As shown in FIG. 1, each of the second column retention structures 22 includes a slot 44 that receives another portion of the corresponding one of the columns 16, as is described in greater detail below.

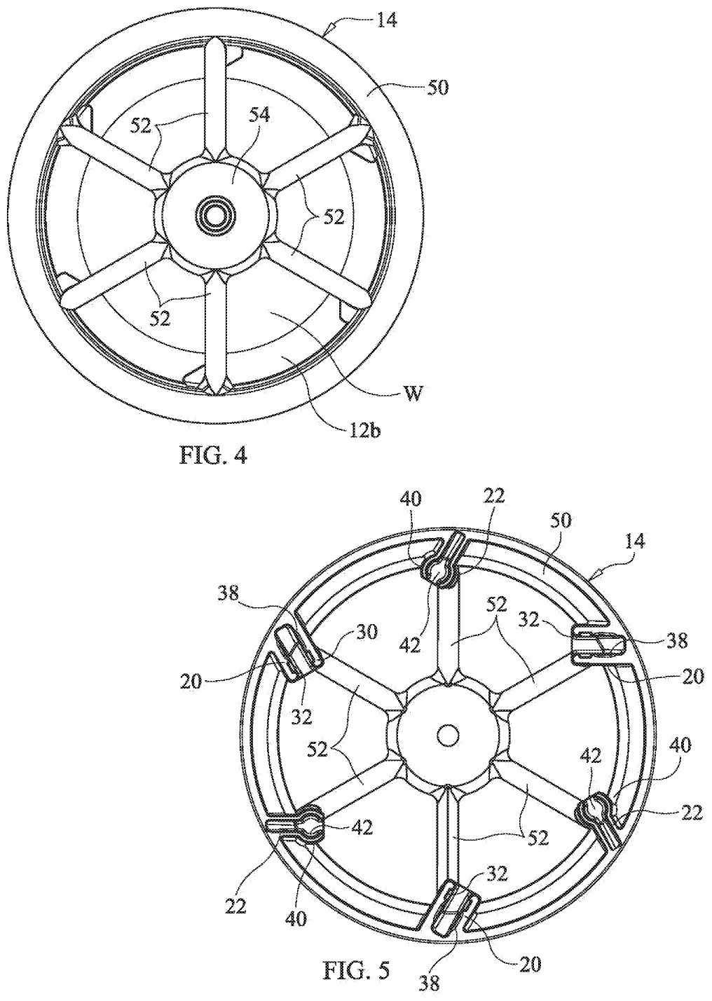

As shown in FIGS. 1, 2, 4 and 5, the upper member 14 is defined by an outer ring 50, spoke-like portions 52 and a central portion 54. The upper member 14 has an overall saucer shape with concaved bottom surfaces 14a and convex upper surfaces 14b. The bottom surface 14a includes three of the first column retention structures 20 and three of the second column retention structures 22 as described above with respect to the base member 12. Hence the three of the first column retention structures 20 and three of the second column retention structures 22 are numbered the same as the three of the first column retention structures 20 and three of the second column retention structures 22 of the base member 12.

As shown in FIGS. 3 and 8, the plurality of columns 16 include six identical columns 16. Description of one of the columns 16 applies equally to all six columns 16. Each column 16 is an elongated member with a first end 60 and a second end 62.

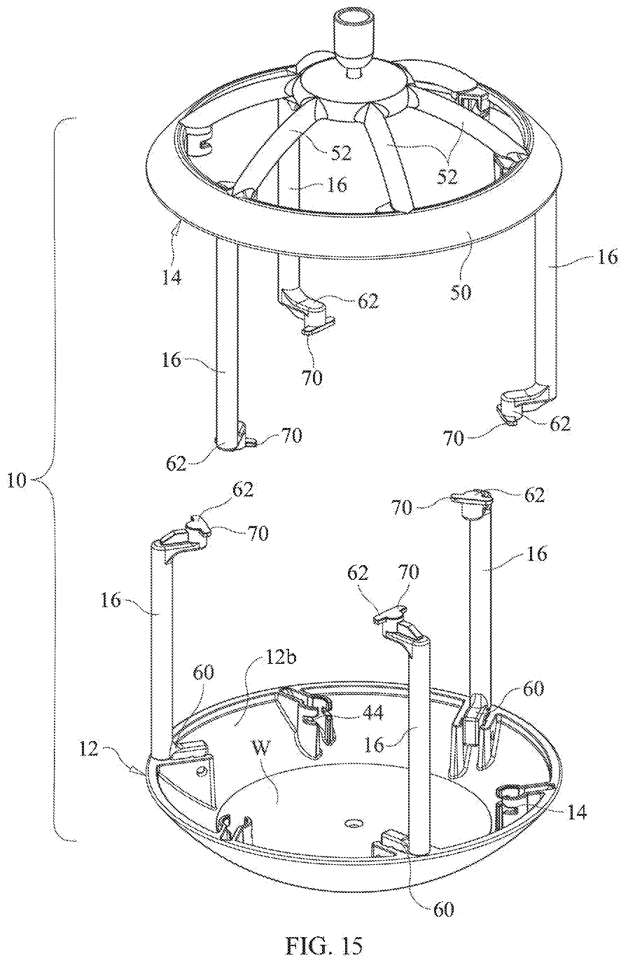

The first end 60 includes a pivot pin 66 and a detent 68. The first end 60 is fitted into the gap 32 of a corresponding one of the first column retention structure 20 such that the pivot pin 66 is fitted into the openings 34 in the wall sections 30. The first end 60 of three of the columns 16 are attached in this way to the three first column retention structures 20 of the base member 12 and the first end 60 of the other three of the columns 16 are attached in this way to the three first column retention structures 20 of the upper member 14, as shown in FIG. 15.

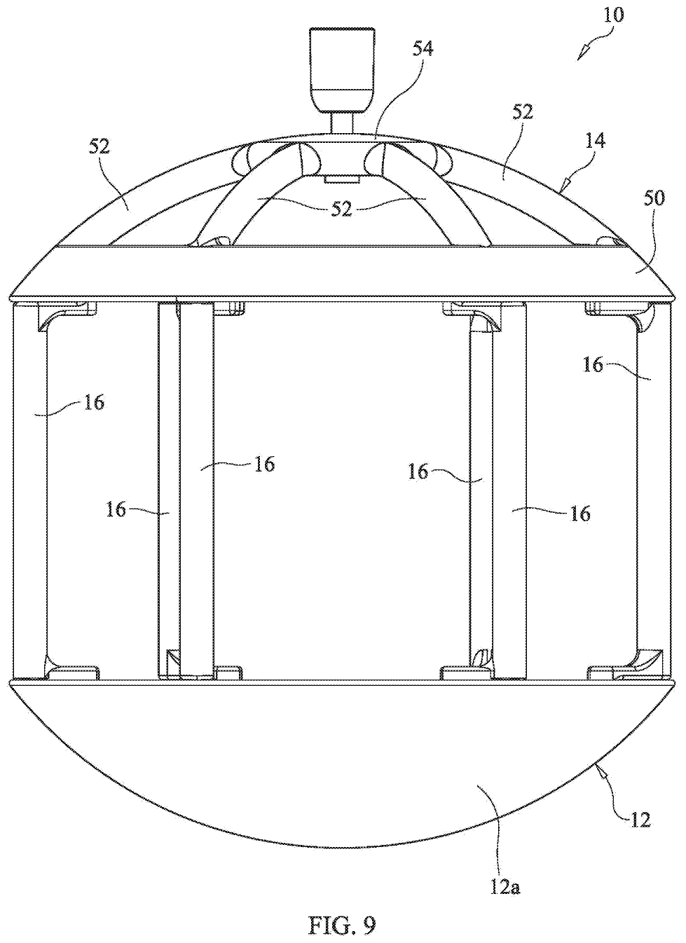

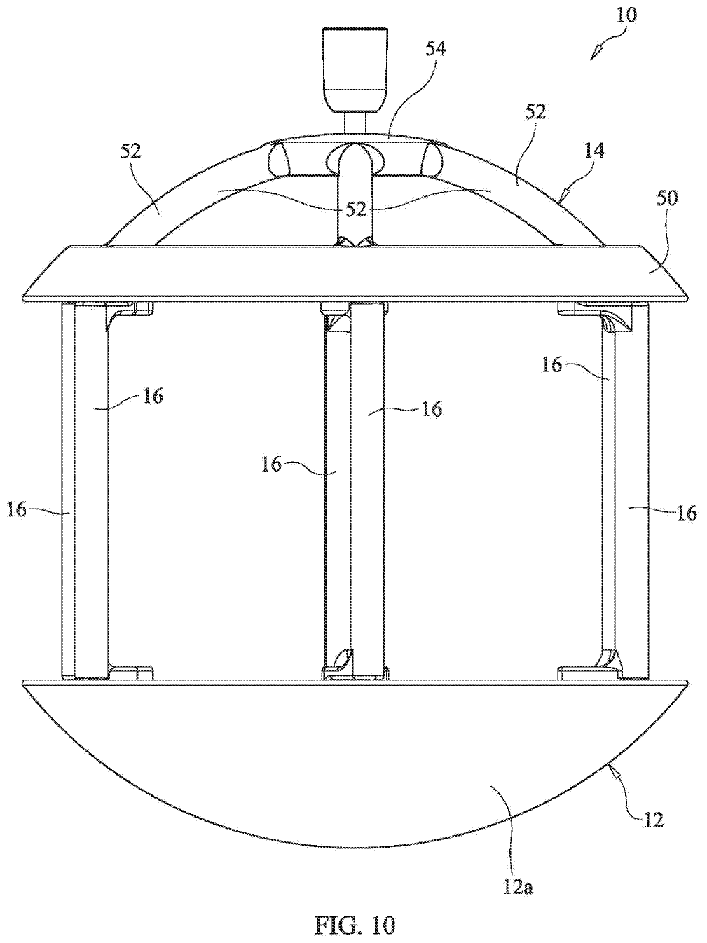

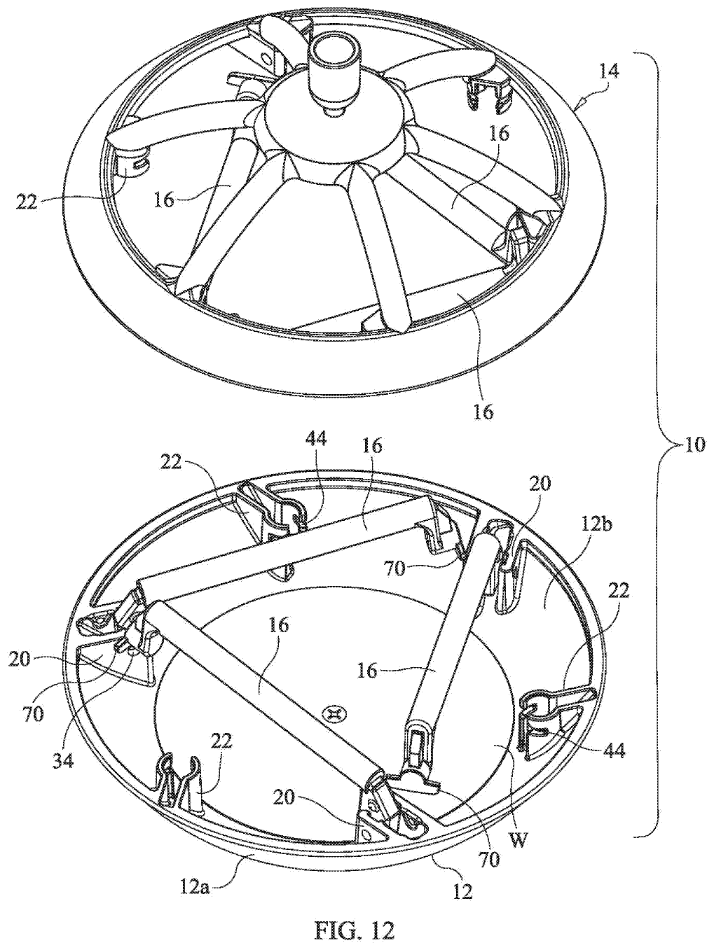

The columns 16 with first ends 60 installed to corresponding ones of the first column retention structures 20 pivot about the pivot pin 66 between an in-use orientation (FIGS. 1-2 and 9-10 and a storage orientation (FIGS. 12-14). In other words, the first ends 60 and the first column retention structures 20 are dimensioned to facilitate pivotal movement of the column 16 with respect to the first column retention structures 20. More specifically, in the in-use orientation, the columns 16 extend in a direction that is perpendicular to the radially outer edge 24 of the base member 12 and perpendicular to the upper member 14.

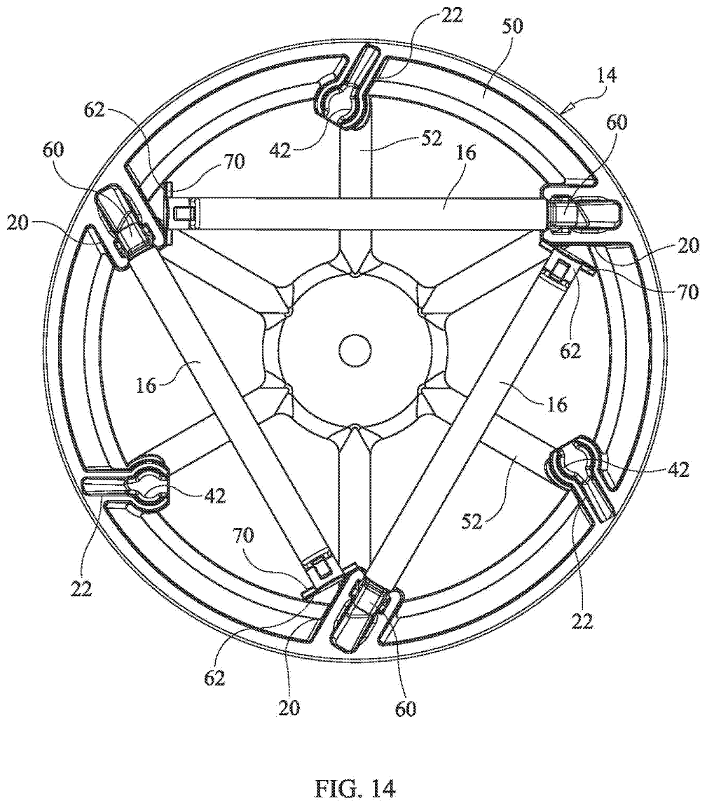

In the storage orientation shown in FIGS. 12-14, the folding cage 10 takes up very little space (FIG. 14) as compared to the folding cage 10 when fully assemblies (FIGS. 1-2 and 9-10).

The detent 68 of the first end 60 is dimensioned to fit between the two wall sections 30, contact the detent area 38 of the first column retention structures 20 and releasably retain the columns 16 in the in-use orientation.

The second end 62 including a snap-fitting structure (a portion of the column 16) that is fitted into the snap-fit area 42 of the second column retention structure 22. The second end 62 also includes a projection 70 that is dimensioned and positioned to fit into the slot 44 of the second column retention structure 22.

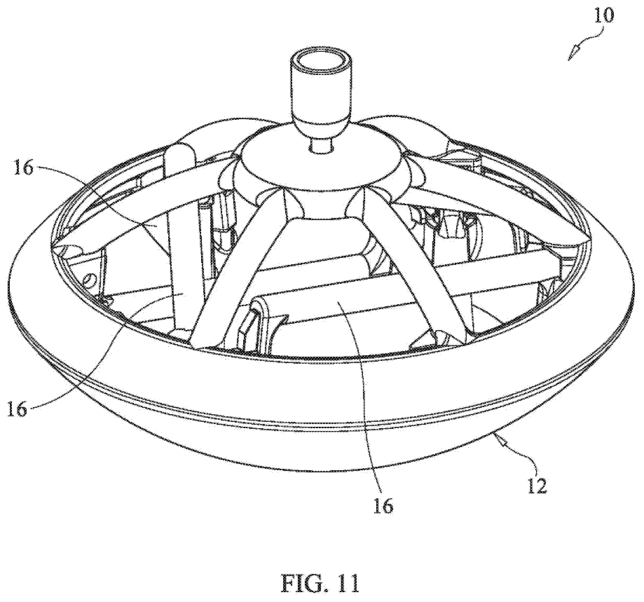

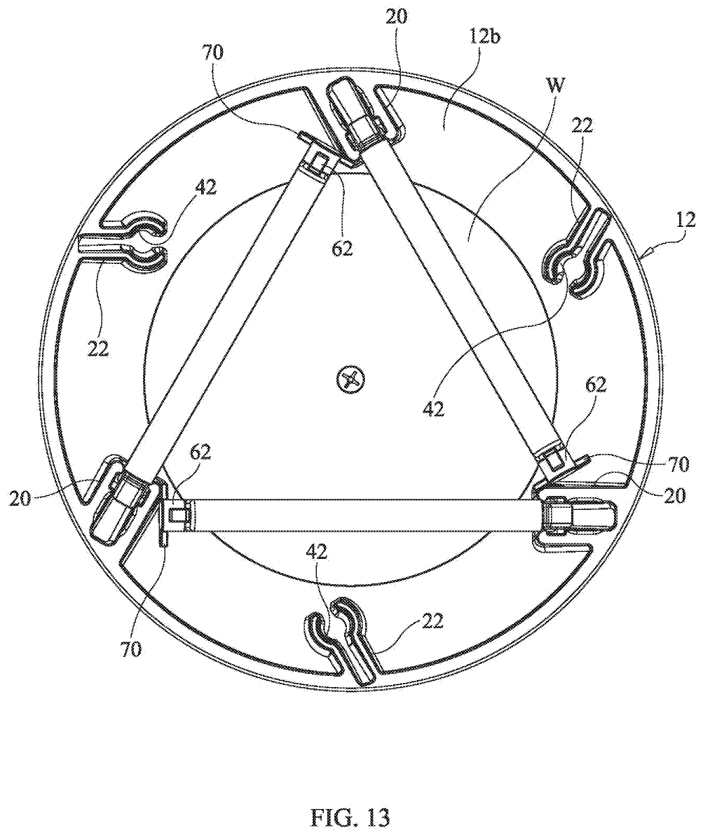

As described above, three of the columns 16 are attached for pivotal movement to the base member 12 and three of the columns 16 are attached for pivotal movement to the upper member 14. When shipped, the columns 16 are folded as shown in FIG. 11 and take of only a fraction of the space required for the fully assembled folding cage 10 shown in FIG. 1. Once taken out of its packaging or out of storage, the base member 12 and the upper member 14 can be separated from one another as shown in FIGS. 12 and 13. Next as shown in FIG. 14, the three columns 16 having their first end 60 attached to the base member 12 can be unfolded such that they are perpendicular to the base member 12. Next as shown in FIG. 14, the three columns 16 having their first end 60 attached to the upper member 14 can be unfolded such that they are perpendicular to the base member 12.

Thereafter, the second ends 62 of the three columns 16 pivotally attached to the upper member 14 can be attached to the second column retention structures 22 of the base member 12. This is accomplished by pivoting the column 16 about the pivot pin 66, snap fitting a corresponding portion of the column 16 into the snap-fitting area 42 and simultaneously inserting the projection 70 into the corresponding slot 44. Finally, the second ends 62 of the three columns 16 pivotally attached to the base member 12 are attached to the second column retention structures 22 of the upper member 14.

The folding cage 10 when placed on a floor or other flat surface will rock and pivot about the convex bottom surface 12a of the base member 12. The weight W is attached to the base member 12 and using gravity urges the folding cage 10 to an upright orientation as shown in FIGS. 1, 2 and 9-10. Thus, a pet's appreciation of the folding cage 10 is improved by inclusion of the weight W, while an owners appreciation of the folding cage 10 is increased by the reduction in size of the folding cage 10 when disassembled for storage.

The folding cage 10 can have treats or large objects can be inserted therein during assembly such that when a pet plays with the folding cage 10 the pet's appreciation and enjoyment playing with the folding cage 10 is enhanced.

Further, the folding cage 10 need not take up much storage space because the upper member 14 can be separated from the lower member 12. The columns 16 can be folded to the corresponding one of the upper member 14 and the lower member 12 for easy storage in a space that is significantly less than the space required to store the fully assembled folding cage 10.

All elements of the folding cage 10 (except the weight W) can be made of plastic, polymer materials or other relatively rigid materials.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiment, the following directional terms “forward”, “rearward”, “above”, “downward”, “vertical”, “horizontal”, “below” and “transverse” as well as any other similar directional terms refer to those directions of a vehicle equipped with the folding cage. Accordingly, these terms, as utilized to describe the present invention should be interpreted relative to a vehicle equipped with the folding cage.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A folding cage, comprising
a base member;
an upper member; and
a plurality of columns each extending between the base member and the upper member connecting the base member to the upper member, with at least one of the plurality of columns being attached to the base member for pivotal movement with respect thereto and at least one of the plurality of columns being attached to the upper member for pivotal movement with respect thereto.

2. The folding cage according to claim 1, wherein
each column having a first end and a second end, the first end having pivot pins and the second end including a snap-fitting structure such that the first end of the at least one of the plurality of columns is attached to the base member for pivotal movement, and the second end of the at least one of the plurality of columns is releasably attached to the upper member.

3. The folding cage according to claim 2, wherein
the second end of the at least one of the plurality of columns attached to the base member for pivotal movement is snap-fitted to the upper member and the second end of the at least one of the plurality of columns attached to the upper member is snap-fitted to the base member.

4. The folding cage according to claim 1, wherein
the plurality of columns includes six columns with three of the columns being attached for pivotal movement to the base member and three of the columns being attached for pivotal movement to the upper member.

5. The folding cage according to claim 4, wherein
the three columns attached to the base member are pivotable from a first orientation perpendicular to the base member to a second orientation parallel to the base member, and the three columns attached to the upper member are pivotable from a third orientation perpendicular to the upper member to a fourth orientation parallel to the upper member.

6. The folding cage according to claim 1, wherein
each column having a first end and a second end, the first end having pivot pins and the second end including a snap-fitting structure.

7. The folding cage according to claim 5, wherein
the plurality of columns includes six columns with the first ends of a first set of three of the columns being attached for pivotal movement to the base member and the second ends of the first set of three of the columns are snap fitted to the upper member, and
the first ends of a second set of three of the columns being attached for pivotal movement to the upper member and the second ends of the second set of three of the columns are snap fitted to the base member,

8. The folding cage according to claim 6, wherein
the base member includes at least one first column retention structure and at least one second column retention structure, the first column retention structure having a pivot pin opening dimensioned and shaped to receive the pivot pin at the first end of a corresponding one of the plurality of columns, the second column retention structure includes a block with a gap formed there in dimensioned to receive and releasable retain the second end of a corresponding one of the plurality of columns.

9. The folding cage according to claim 1, wherein
the base member includes at least one first column retention structure and at least one second column retention structure the first column retention structure having a pivot pin receiving structure and the at least one second column retention structure includes a block with a gap formed therein, and
the upper member includes at least one first column retention structure and at least one second column retention structure the first column retention structure having a pivot pin receiving structure and the at least one second column retention structure includes a block with a gap formed therein.

10. The folding cage according to claim 9, wherein
each column includes a first end and a second end, the first end having pivot pins and the second end including a snap-fitting structure.

11. The folding cage according to claim 10, wherein
the first end of a first column of the plurality of columns is installed to the at least one first column retention structure of the base member such that the first column is pivotal about the at least one first column retention structure of the base member and the second end of the first column of the plurality of columns is releasably attached to the at least one second column retention structure of the upper member.

12. The folding cage according to claim 11, wherein
the first end of a second column of the plurality of columns is installed to the at least one first column retention structure of the upper member such that the second column is pivotal about the at least one first column retention structure of the upper member and the second end of the second column of the plurality of columns is releasably attached to the at least one second column retention structure of the base member.

13. The folding cage according to claim 10, wherein
each of the first ends of the plurality of columns includes a detent dimensioned to retain the plurality of columns in an orientation perpendicular to both the base member and the upper member.
